(19) United States
(12) Patent Application Publication
(10) Pub. No.: US 2002/0013775 A1
(43) Pub. Date: Jan. 31, 2002

(54) METHOD OF PROCESSING A REQUEST TO A BOOLEAN RULE AND A COMPUTER READABLE MEDIUM ENCODED WITH A PROGRAM FOR PERFORMING SAID METHOD

(76) Inventor: HANS JORGEN SKOVGAARD, FARUM (DK)

Correspondence Address: OLIFF & BERRIDGE, P O BOX 19928, ALEXANDRIA, VA, 22320

(21) Appl. No.: 08/998,710

(22) Filed: Dec. 29, 1997

(30) Foreign Application Priority Data
Sep. 9, 1997 (DK) 1029/97

(51) Int. Cl. G06N 5/02

(52) U.S. Cl. 706/48

(57) ABSTRACT

There is provided a method of processing a request to a rule by the use of an input signal, compressed rule information, and an output signal, comprising the steps of: representing said input signal as a plurality of two-bit pairs each pair corresponding to a variable in said input signal, representing the rule information with at least a first and second type of terms. The terms of said first type are each binary words, and each represents one allowable combination of the variables. And each term of said second type is a plurality of two-bit pairs and represents at least two allowable combinations of the variables. The method further comprises the step of testing whether there is a first type of match between at least one of said first terms and said input signal, testing whether there is a second type of match between at least one of said second terms and said input signal, generating an output signal as a plurality of two-bit pairs, each pair corresponding to a variable in said input signal, updating said output signal according to the following strategy: if there is a match of said first type, then the output signal is updated with values which are responsive to at least one of said first type of terms. And if there is a match of said second type, then the output signal is updated with values which are responsive to at least one of said second type of terms.

### FIELD OF THE INVENTION

The invention relates to the field of processing a request to a rule by the use of an input signal, compressed rule information, and an output signal.

### BACKGROUND OF THE INVENTION

This invention relates to the European patent EP 0 456 675, where an input signal has components or elements representing aspects of a physical entity which are in a known state and other components or elements which are unknown. EP 0 456 675 provides a method and an apparatus which processes the signal in accordance with stored data representing rules which indicate which combinations of the components are possible. Rules are identified involving the known components or elements, and all of the combinations consistent with the known states are identified. If all of these combinations have the same value for a particular element, the element is determined to have that value in the output signal. The rules are stored as binary representations of the possible combinations, and the elements of the input and output signals may represent two allowable states, tautology (undefined state), and inconsistency (inallowable state).

However, the method disclosed in EP 0 456 675 which uses the positive index form for the representation of rules consumes much memory, especially when the rules comprise a large number of variables. Generally, the method requires storage of N/2*(2ˆ N) terms, where N is the number of variables in the formula. This means that a rule like

A [symbol] B or C or D or E or F or G or H or I or J or K or L or M or N or 0 or P

takes up 64 k 16-bits words in memory; with this invention it is possible to compress the representation of the rule such that it takes up only 32 16-bits words in the memory and may be scanned about 2000 times faster in run time.

A special aim of the method disclosed in EP 0 456 675 and the present invention is to use the methods in configuration systems. However, the method is applicable in other fields e.g. in scheduling and planning.

A computer system intended to solve a configuration problem, is a special application of artificial intelligence where the problem can be stated in terms of a set of selectable elements, and a number of relations between these selectable elements. The configuration problem is solved when the set of all selectable elements is completely divided into two disjunct sub-sets representing elements that are included in the configuration and elements that are excluded from the configuration, respectively, without violating any of the relations between the selectable elements.

A selectable element is anything that can be included or excluded. It can be a physical object (e.g. a car or a specific kind of engine), an attribute (e.g. the color red or the texture pattern of a carpet) or something abstract (e.g. a specific number of trips between home and work or a particular type of contract).

A relation is a rule involving one or more selectable elements. The purpose of a rule is to constrain the selection of elements to obey some requirements. A rule can be based on a physical limitation (e.g. if a car needs a large engine to support a large number of selected electrical accessories), or a discretionary decision (e.g. if management decides that all cars having a particular large engine are produced only in red to give them a more sporty look). Often the term ‘Constraint’ is used to refer to a rule limiting the elements that can be combined.

### CROSS REFERENCES

Reference is made to the following patent applications, filed the same day as this application and assigned to the same assignee, Beologic A/S:

(1) A Method of Configuring a Set of Objects in a Computer

(2) A Method and Apparatus for Inference of Partial Knowledge in Interactive Configuration

(3) Configuration via Network

(4) A method of enabling Invalid Choices in Interactive Configuration Systems

which are hereby incorporated as references to be understood in connection with the present invention.

### SUMMARY OF THE INVENTION

An object of the invention is to provide a method which allows fast processing of a request to rule, such that it is verified whether the request violates the rule, i.e. is in contradiction with the rule, and such that unknown information in the request may be, but not necessarily is determined.

There is provided a method of processing a request to a rule by the use of an input signal, compressed rule information, and an output signal, comprising the steps of: representing said input signal as a plurality of two-bit pairs, each pair corresponding to a variable in said input signal; representing the rule information with at least a first and a second type of terms; each of said terms of the first type being binary words and each representing one allowable combination of the variables; each of said terms of the second type being a plurality of two-bit pairs and representing at least two allowable combinations of the variables; testing whether there is a first type of match between at least one of said first terms and said input signal; testing whether there is a second type of match between at least one of said second terms and said input signal; generating an output signal as a plurality of two-bit pairs, each pair corresponding to a variable in said input signal; updating said output signal according to the following strategy: if there is a match of said first type, then the output signal is updated with values which are responsive to at least one of said first type of terms; if there is a match of said second type, then the output signal is updated with values which are responsive to at least one of said second type of terms.

There is thereby provided a method which combines a compressed and uncompressed term representation for a rule, which is very fast regarding computational time and which is very efficient regarding memory consumption.

This is possible in particular when the method comprises the step of: generating said input signal as a subset of variables from a global input signal, wherein said subset of variables is determined as those variables involved in said rule.

The computational effort required for the processing of a request may hereby be reduced significantly if an actual rule only involves a limited subset of a large set of variables.

Since the processing of the request results in an output signal, it is moreover expedient if the method further comprises the step of: generating a global output signal having variables, wherein some of the variables are updated with variable values from said output signal.

Thereby, the information in the limited subset is transferred to the large set of variables.

Alternatively, there is provided a method of processing a request to a rule by the use of an input signal, compressed rule information, and an output signal, comprising the steps of: representing the input signal as a plurality of two-bit pairs, each pair corresponding to a variable in the input signal, representing the rule information with at least one type of terms, each of the terms of said type being a plurality of two-bit pairs and representing at least one allowable combination of the variables, testing whether there is a match between at least one of said terms and said input signal, updating an output signal which is a plurality of two-bit pairs such that if there is a match, then the output signal is updated with values which are responsive to at least one of said terms.

Further, there is provided a method of processing a request to a rule by the use of an input signal, compressed rule information, and an output signal, comprising the steps of: representing said input signal as a plurality of bit structures, each structure corresponding to a variable in said input signal; representing the rule information with at least a first and a second type of terms; each of said terms of the first type being binary words and each representing one allowable combination of the variables; each of said terms of the second type being a plurality of bit structures and representing at least two allowable combinations of the variables; testing whether there is a first type of match between at least one of said first terms and said input signal; testing whether there is a second type of match between at least one of said second terms and said input signal; generating an output signal as a plurality of bit structures, each structure corresponding to a variable in said input signal; updating said output signal correspondingly, if there is a match of one of said types.

Consequently, it is possible to represent terms for a rule, which is very fast regarding computational time and which is very efficient regarding memory consumption. Thereby it is possible to have only one type of terms and still feasible features such as computational time efficient memory consumption.

Further, the invention relates to a computer readable medium encoded with a program for performing the method as described above.

### BRIEF DESCRIPTION OF THE DRAWINGS

The invention will be explained more fully below in connection with a preferred embodiment and with reference to the drawing, in which:

FIG. 1 shows a flow chart for a method of generating a compressed rule representation;

FIG. 2 shows a parse tree for the formula: (X or Y) [symbol] Z;

FIG. 3 shows four state vectors and indicates scanning of compressed and uncompressed terms according to the invention;

FIG. 4 is the overall structure of a preferred embodiment of the present invention;

FIG. 5 shows a flow chart for a method of generating a local input state vector from a global input state vector;

FIG. 6 shows a flow chart for a method of scanning uncompressed terms;

FIG. 7 shows a flow chart for a method of scanning compressed terms;

FIG. 8 shows a flow chart for a method of extracting information.

### DETAILED DESCRIPTION OF A PREFERRED EMBODIMENT

In European Patent EP 0 456 675, which is hereby incorporated as a reference, a boolean formula is represented by the positive index form of that formula.

### EXAMPLE 1

For the formula

A or !B [symbol] !C

‘if A or not B, then not C’, with the boolean variables A, B, and C, the positive index form is given in table 1.

TABLE 1

| Term No. | A | B | C |
|---|---|---|---|
| 1 | 0 | 0 | 0 |
| 2 | 0 | 1 | 0 |
| 3 | 0 | 1 | 1 |
| 4 | 1 | 0 | 0 |
| 5 | 1 | 1 | 1 |

The five terms in table 1 represent exactly all the combinations of the variables where the formula is valid (not violated).

In a computer the contents of table 1 could conveniently be represented by means of S bytes or one bit per variable per term in the memory.

According to the present invention the boolean rule representation is changed from the use of the two states true and false to the three states true, false, and don't care. The don't care state represents tautology which implies that a don't care state may take the value true as well as false without violating the represented rule. The don't care state is indicated by a star (*) in the representation of the positive index form of a formula.

The formula

A or !B [symbol] !C

may thereby be represented as given in table 2.

TABLE 2

| Term No. | A | B | C |
|---|---|---|---|
| 1, 4 | * | 0 | 0 |
| 2 | 0 | 1 | 0 |
| 3, 5 | * | 1 | 1 |

Compared with table 1, table 2 comprises two rows less than table 1. It is clear from table 2 that the last row may be expanded to the terms 3 and 5 in table 1. A compressed rule representation is hereby introduced.

On a computer, the compressed positive index form utilizes faster execution speed and consumes less memory. One term that includes a don't care “*” can be represented with a two bit representation for each variable. The three symbols {0,1,*} used for the compressed representation are shown in table 3 along with the binary assignment of the bits S1 and S2 in the two bit representation.

TABLE 3

| | True | False | Don't care |
|---|---|---|---|
| | (1) | (0) | (*) |
| S1 | 0 | 1 | 1 |
| S2 | 1 | 0 | 1 |

The exact choice of bit combinations is very important to the rule scanning algorithm because essential operations can be made with simple and/or operations. The bit combinations may be chosen such that those operations which are assumed to be executed most frequently are the fastest operations to execute. The compressed version may conveniently be represented by 5 bytes in the memory i.e. two bytes per compressed term and one byte per uncompressed term. However, for rules with more variables significant memory savings can be achieved.

### EXAMPLE 2

For the rule

A or B or C or D or E or F or G or H or I or J [symbol] K

TABLE 4
The positive index form is given in table 4:

| Term No. | A | B | C | D | E | F | G | H | I | J | K |
|---|---|---|---|---|---|---|---|---|---|---|---|
| 1 | 0 | 0 | 0 | 0 | 0 | 0 | 0 | 0 | 0 | 0 | 0 |
| 2 | 0 | 0 | 0 | 0 | 0 | 0 | 0 | 0 | 0 | 0 | 1 |
| 2 | 0 | 0 | 0 | 0 | 0 | 0 | 0 | 0 | 0 | 1 | 1 |
| 4 | 0 | 0 | 0 | 0 | 0 | 0 | 0 | 0 | 1 | 0 | 1 |
| . . . | . . . | | | | | | | | | | |
| 1025 | 1 | 1 | 1 | 1 | 1 | 1 | 1 | 1 | 1 | 1 | 1 |

The uncompressed terms in table 4 requires two bytes times 1025 terms, equal to 2050 bytes. The compressed term representation is given in table 5.

TABLE 5

| Term No. | A | B | C | D | E | F | G | H | I | J | K |
|---|---|---|---|---|---|---|---|---|---|---|---|
| 2-1025 | * | * | * | * | * | * | * | * | * | * | 1 |
| 1 ,2 | 0 | 0 | 0 | 0 | 0 | 0 | 0 | 0 | 0 | 0 | * |

This compressed representation requires two bytes times two bytes per term times two terms, equal to eight bytes.

For this rule, a significant saving is obtained in memory consumption, even though the compressed term representation uses twice as much memory per term, i.e. two bits per variable.

The generation of compressed terms is well known from the field of digital design. Karnaugh cards are one method and a method such as the Quine-McCluskey method (1965) can be found in Morris Mano's book Digital Design. An overlapping set of terms is generated by the Quine-McCluskey method.

However, we use a method by Antoine Rauzy “Boolean Unification, an efficient algorithm” 1989. This method generates a non overlapping set of terms.

The principle of the algorithm is to construct a decision tree recursively. Let f be a formula. The application of the algorithm for f can be viewed as a succession of couples <ActiveList; ResultList> where ActiveList is a sequence of open tableaux labelings, the unexplored nodes of the tree. ResultList is a set of open tableaux labelings reached in the previous steps and such that the reductions of the labeling are equal to true in the formula f.

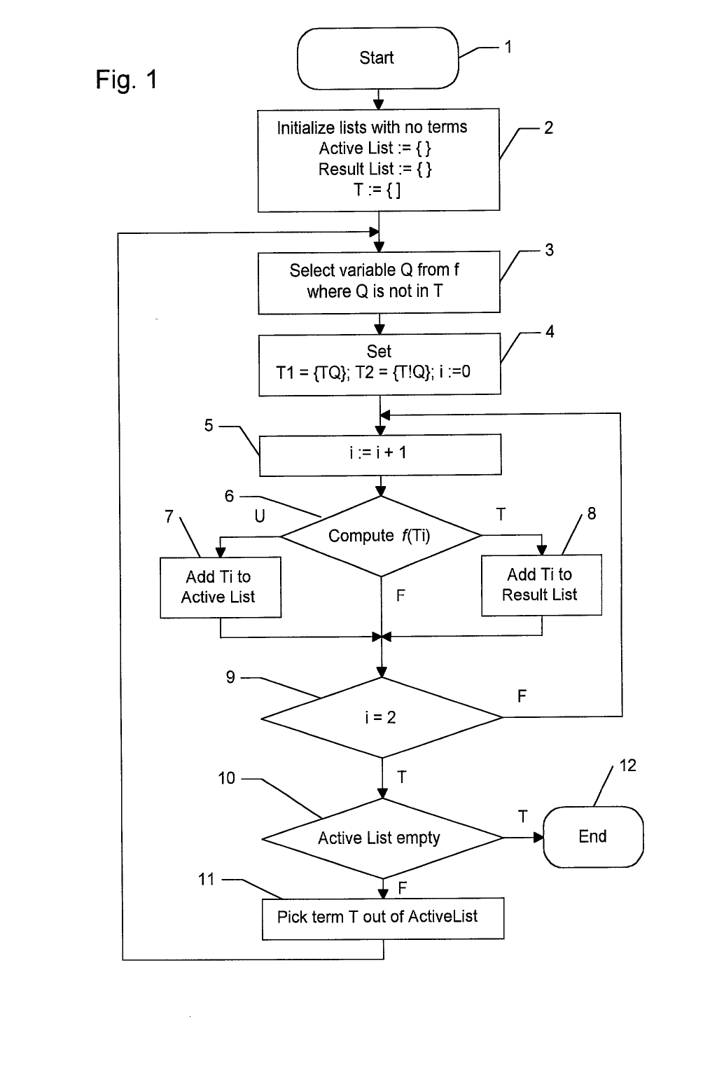

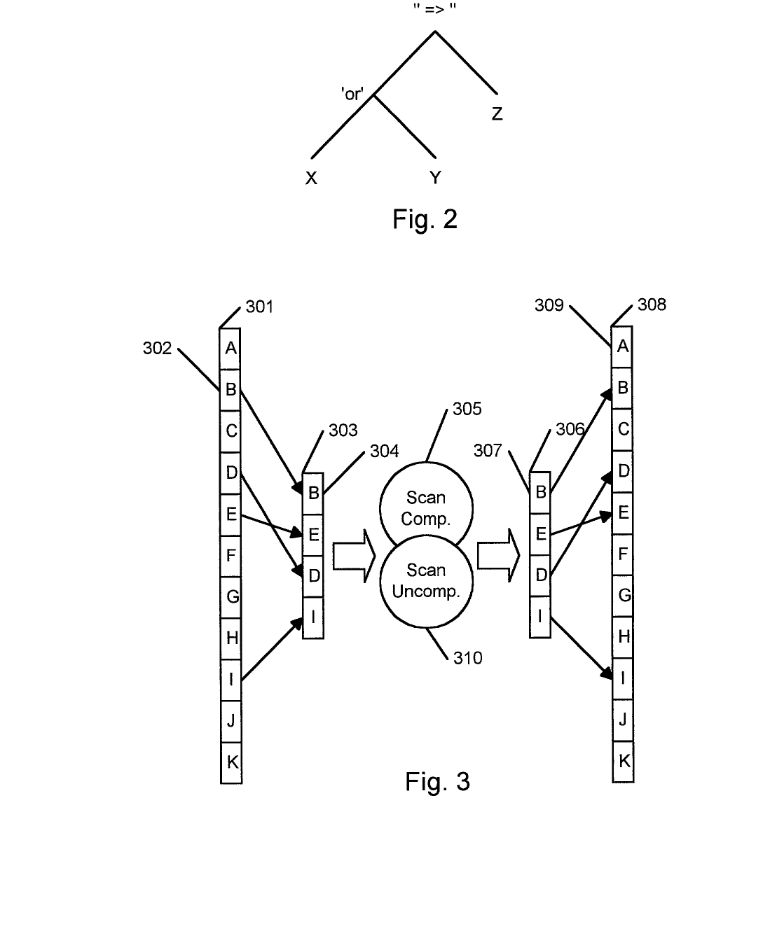

FIG. 1 shows a flow chart for a method of generating a compressed rule representation. In step 1, the method begins with a symbolic boolean formula which is subject for a compressed representation. In step 2 an initialization process comprises assigning of the variables ActiveList and ResultList to the empty set and T to the empty set. When the initialization is done, a variable Q in the formula f, which is not in the term T at present, is selected in step 3. If several variables are possible, then the topmost one in the associated parse tree (see FIG. 2) is selected, i.e. the variable governed by the fewest operators is selected. In case of ties, a variable is chosen at random. In step 4 the two terms T1 and T2 are generated, where T1 is T with Q added and T2 is T with the negated Q added. Each term respectively represents one side of the parse tree. Furthermore a counter i is initialized. Then a loop is entered, and the first step 5 of the loop is to increment the counter, i.e. i is set equal to i+1. The next step 6 in the loop is to compute the truth value of the function f with respect to the known variable values in T1 or T2 that is the value of f(Ti). The truth value is calculated by means of a calculator which uses the rewrite rules given in table 6. The symbol A may represent both a variable and a sub-formula.

TABLE 6

| Rule No. | Rules |
|---|---|
| R1 | false and A : [symbol] false |
| R2 | false or A : [symbol] A |
| R3 | false [symbol] A : [symbol] true |
| R4 | A [symbol] false : [symbol] not A |
| R5 | false [symbol] A : [symbol] not A |
| R6 | not false : [symbol] true |
| R7 | false xor A : [symbol] A |
| R8 | true and A : [symbol] A |
| R9 | true or A : [symbol] true |
| R10 | true [symbol] A : [symbol] A |
| R11 | A [symbol] true : [symbol] true |
| R12 | true [symbol] A : [symbol] A |
| R13 | not true : [symbol] false |
| R14 | true xor A : [symbol] not A |

The rewrite rules are derived directly from the Boolean algebra. If all variables are known then it is easy to determine the truth value of the formula f, however with only partial assignment the truth value may be undetermined in some cases.

It is only necessary to compress a rule once, since the rule representation may be stored.

FIG. 2 shows a parse tree for the formula: (X or Y) [symbol] Z. The top node of the tree corresponds to the ‘ [symbol] ’ or implication in the formula. The other node corresponds to the or-operator. X, Y, and Z are the variables of the parse tree.

### EXAMPLE 3

For the formula

(X or Y) [symbol] Z

where Z is equal to True (Z:=true), the formula is

(X or Y) [symbol] True

according to R11 the formula is “True”, i.e. the truth value is True irrespective of the assignment of X and Y. For another term T=!XY, the formula is

(False or True) [symbol] Z

according to R9 “True [symbol] Z” and according to R10 “Z”, and therefore the truth value cannot be determined in this case. In the event that the truth value of the formula cannot be determined, the result of the computation in step 6 is ‘unkonwn’, and then Ti is added to the Active-List in step 7 for further processing in loop comprising the steps 3 to 11. In the event that the truth value of the formula is evaluated to be ‘True’ in step 6, then the term T is added to the ResultList as a valid compressed term in step 8. In the event that the truth value of the formula is evaluated to be ‘False’ in step 6, or Ti is added to either the ResultList in step 8 or the Active-List in step 7, then it is tested in step 9 whether the counter i is equal to 2. If both T1 and T2 have been computed, it is tested in step 10 whether the ActiveList is empty, otherwise, if T1 and T2 have not been computed, the loop is resumed at step 5, where the counter i is incremented. In step 10 it is tested whether the ActiveList is empty. If it is empty, then the processing is terminated, otherwise a term T is subjected to further processing by taking T out of the ActiveList and resuming the loop in step 3.

If the ActiveList is empty at step 10, the result list contains a set of terms representing the positive index of the formula in compressed form. The terms are translated into the index form by means of table 7.

TABLE 7

| Term | Compressed Positive |
|---|---|
| Variable | Index |
| A | 1 |
| !A | 0 |
| ‘Not occurring | * |
| in term but in | |
| formula’ | |

Generally, this compressed formula representation takes up memory in the order of N times O bits, where N is the number of variables and O is the number of operators.

### Examples of Compression:

### EXAMPLE 4

In this example, the formula

(X or Y) [symbol] Z

is subjected to a compressed term representation. The succesive updates of the ResultList and ActiveList are shown in table 8 below.

TABLE 8

| Active List (AL) | Result List (RL) |
|---|---|
| [] | [] |
| [{Z}, {!Z}] | [] |
| [{!Z}] | [{Z}] |
| [{Y, !Z}, {!Y, !Z}]] | [{Z}] |
| [{!Y, !Z}]] | [{Z}] |
| [{X, !Y, !Z}, {!X, !Y, !Z}] | [{Z}] |
| [{!X, !Y, !Z}] | [{Z}] |
| [] | [{!X, !Y, !Z}, {Z}] |

Therefore, the compressed positive index form is given as shown in table 9.

TABLE 9

| Term No. | X | Y | Z |
|---|---|---|---|
| 1 | 0 | 0 | 0 |
| 2 | * | * | 1 |

### EXAMPLE 5

In this example, the formula

X [symbol] (Y or Z)

is subjected to a compressed term representation. The succesive updates of the ResultList and ActiveList are shown in table 10 below.

TABLE 10

| Active List (AL) | Result List (RL) |
|---|---|
| [] | [] |
| [{X}, {!X}] | [] |
| [{X,Y}, {X, !Y}] | [{!X}] |
| [{X, !Y}] | [{!X}, {X,Y}] |
| [{X, !Y,Z}, {X, !Y, !Z}] | [{!X}, {X,Y}] |
| [] | [{!X}, {X,Y}, {X, !Y,Z}] |

Therefore, the compressed positive index form is given in table 11.

TABLE 11

| Term No. | X | Y | Z |
|---|---|---|---|
| 1 | 0 | * | * |
| 2 | 1 | 1 | * |
| 3 | 1 | 0 | 1 |

To optimize the use of memory, the terms that do not have any don't cares * will be kept in a list separate from those that don't cares *.

A Boolean formula is henceforth represented as a structure with three elements

Formula=(VL, PIL, CPIL)

where VL is Variable List, PIL is an uncompressed Positive Index List, and CPIL is a Compressed Positive Index List, containing a list of pairs {S1, S2}.

### EXAMPLE 5 (CONTINUED)

Remembering the Boolean rule

X [symbol] (Y or Z),

the contents of the ResultList in table 10 and the translations given in table 3 and 7, give the data representation of the formula

Formula=([X,Y,Z], [101], [{001,111},{111,011}])

### EXAMPLE 2 (CONTINUED)

Remembering the Boolean rule

A or B or C or D or E or F or G or H or I or J [symbol] K,

the term representation in table 5 gives the data representation of the formula:

Formula=([A,B,C,D,E,F,G,H,I,J,K], [000000 00000], [{11111111110,11111111111}])

Thus it is clear that this representation is very efficient.

FIG. 3 shows four state vectors and indicates scanning of compressed and uncompressed terms according to the invention. The overall structure of the scanning algorithm is divided into four stages. At stage one a request to a rule is prepared. The request is in the form of a state vector, and the rule is in the form of a formula represented by the compressed and uncompressed terms. That is, a local input state vector (ISV) 303 with elements 304 is generated by extracting information from the global state vector 301 with elements 302. The information is extracted such that only the variables involved in the formula are extracted. This minimizes the computational effort required in the processing of the request to the rule. The processing comprises two stages: scanning of compressed and uncompressed terms.

At stage two 305 the local input state vector is scanned through all uncompressed terms of the formula to test for ‘match’ or no ‘match’, and the relevant elements 307 of the local output state vector (OSV) 306 are updated with the result of the uncompressed scanning.

At stage three 310 the local input state vector (ISL) 303 is scanned through all the compressed terms of the formula to test for ‘match’ or ‘no match’. The information retrieved by the scanning is contained in the local output state vector (OSV). At stage four the contents of the local output state vector are transferred to the global output state vector 308 with elements 309.

A request in the form of an input state vector comprises information about known aspects of an element, for example the state of sensors or configuration selections, but generally other elements of the state vector will be unknown. The information may be contained in elements of a state vector having variable values. The request processing at stage two and four scans a Boolean formula with the knowledge of the current assignments of variables found in the state vector. One object of the invention is to determine some or all of the unknown elements where the rule enables this. The result of the request is updated in the output state vector.

If a contradiction between the request and the rule is detected, i.e. the formula is violated, then the algorithm ends, and if the formula is valid, it is determined whether any further variables may be deduced, i.e. assigned a value in the state vector. The state vector can physically be any data repository such as a data base or a set of objects with associated values about a set of Boolean items occurring in the formula.

The input state vector and the output state vector comprise the variable values which occur in the formula. Each variable in the state vector is stored in the form of one of four possible two-bit combinations.

TABLE 12

| | True | False | Tautology | Contradicion |
|---|---|---|---|---|
| | (1) | (0) | (*) | (!) |
| S1 | 0 | 1 | 1 | 0 |
| S2 | 1 | 0 | 1 | 0 |

Table 12 shows the possible variable values of the two bits S1 and S2 in the state vector.

It should be noted that this is the same convention as used for representing the compressed terms for the symbolic values ‘True’, ‘False’, and ‘Tautology’ (don't care).

The scanning process can be seen as looking at the terms of the formula one by one. If there is a match between the variables bound in the input state vector and the terms (i.e. the rule representation), then the unbound variables may have the value represented in the term. Bounded variables may take the symbolic values ‘True’ or ‘False’, whereas unbounded variables may take the symbolic value ‘Tautology’.

The following table determines whether a match exists or not between a rule term and an input state vector variable. A match between a term and the input state vector is detected if all the variables of that term match with the input state vector.

TABLE 13

| 0 | 0 | Match |
|---|---|---|
| 0 | 1 | No Match |
| 0 | * | Match |
| 1 | 1 | Match |
| 1 | * | Match |
| * | * | Match |
| Table 13 shows which combinations of ‘0’ (false), ‘1’ (true), | | |
| # and ‘*’ (don't care/tautology) result in a ‘match’ or ‘no match’. | | |

When looking at the actual chosen bit representation, both bits have to differ in order to detect a ‘no match’.

When a match has been detected, the knowledge about the matching term is stored in an output state vector using the following update table.

TABLE 14

| | Output | New Output |
|---|---|---|
| | State | State |
| Term | Vector | Vector |
| Variable | Variable | Variable |
| 0 | ! | 0 |
| 1 | ! | 1 |
| * | ! | * |
| 1 | 0 | * |
| 0 | 1 | * |
| * | 0 | * |
| * | 1 | * |
| 0 | 0 | 0 |
| 1 | 1 | 1 |
| * | * | * |
| Table 14 shows the update of the output state vector responsive to the term variable and the | | |
| # previous output state vector. | | |

When looking at the chosen bit representation given in table 12 and the output update in table 14, it is now possible to update the output state vector by a simple Boolean OR operation.

### EXAMPLE 5 (CONTINUED I)

Remember the rule

X [symbol] (Y or Z),

now with a request where external assignments have been made in the state vector. The assignment is that Z is set to false, X is set to true, and there is no knowledge about Y, i.e. tautology. The input state vector is

[X Y Z]=[1*0]

and the term representation is as given in table 11.

TABLE 15

| | X | Y | Z | | | | | |
|---|---|---|---|---|---|---|---|---|
| Input State | | | | | | | | |
| Vector = | [1 | * | 0] | | | | | |
| | | | | | Output State | | | Step |
| | | | | | Vector = | | | No |
| term 1 → | 0 | * | * | → No match | [! | ! | !] | 1 |
| term 2 → | 1 | 1 | * | → Match | [1 | 1 | *] | 2 |
| term 3 → | 1 | 0 | 1 | → No Match | [1 | 1 | *] | 3 |

Table 15 shows the input state vector, the representation of terms 1, 2, and 3 and the three succesive updates of the output state vector. The output state vector is by default initialized to ‘contradiction’ (!) for all elements in the output state vector. Thus, because no match is found between the input state vector and term 1, the output state vector is not updated in step 1. In step 2 there a match is detected, and therefore the output state vector is updated according to table 14. In step 3 there no match is found either, and the output state vector remains unchanged. Match/no match is detected by means of table 13.

Now when looking at the output state vector and eliminating those elements that were bound in the input state vector, it can be seen that Y must be true according to the rule terms. This implies that Y may take the value True and may now be transferred to the output state vector with that value.

The bitwise determination of whether there is a match or not and the updating of the output variables can be done by the four operations “and, or, not, xor”, if the representations given in table 3 and 12 is used. Generally, a computer executes these basic operations very fast. If the signal components S1 and S2 are represented by means of e.g. two words, then a 32-bit computer can execute a term match process in two basic operations for formulas with less than 32 variables. Rules with less than 32 variables are the most common rules.

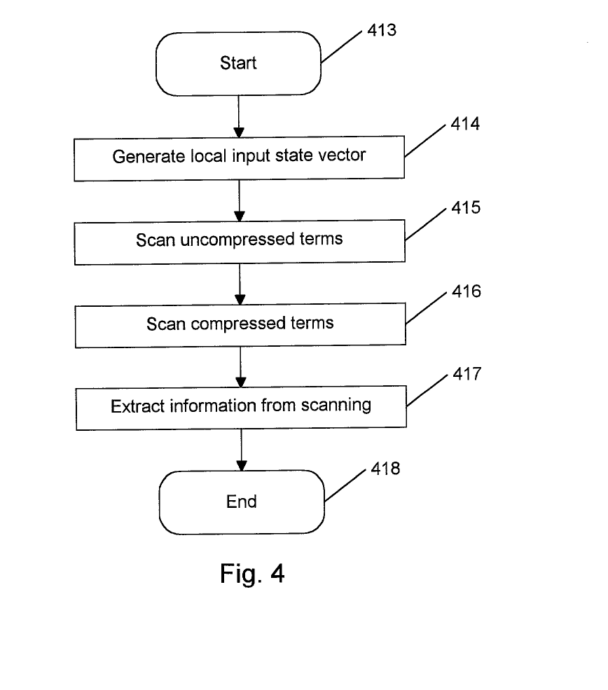

FIG. 4 is the overall structure of a preferred embodiment of the present invention. The structure is divided into four stages i.e. 414, 415, 416, and 417. The detailed method used in a preferred embodiment is presented in each of these four stages. Start 413 and end 418 indicates where the method is initiated and where no further processing takes place. Stage one 414 corresponds to the global to local input state vector conversion in FIG. 3, and stage four corresponds to the local to global output state vector conversion.

Description of Variables in Scanning Algorithm:

StateVector: Is a vector where all the variables are represented by their current value. The value of StateVector[A] is the current truth value of A (True, False, Unbound).

TV is a bit mask indicating the True variables in input state vector with a binary ‘1’.

BV is a bit mask indicating the bounded variables in input state vector with a binary ‘1’.

ISV is the local input state vector.

OSV is the local output state vector.

CH is a bit mask indicating the changed variables in input state vector with a binary ‘1’. . . .

All operators (and, or, xor, not) are.

|X| means the length of X, e.g. |X|=|{a,b,s,d}|4.

Formula=(VL, PIL, CPIL), where

VL is a variable list.

PIL is a positive index list.

CPIL=[{S1, S2}] is a compressed positive index list of pairs {S1, S2}.

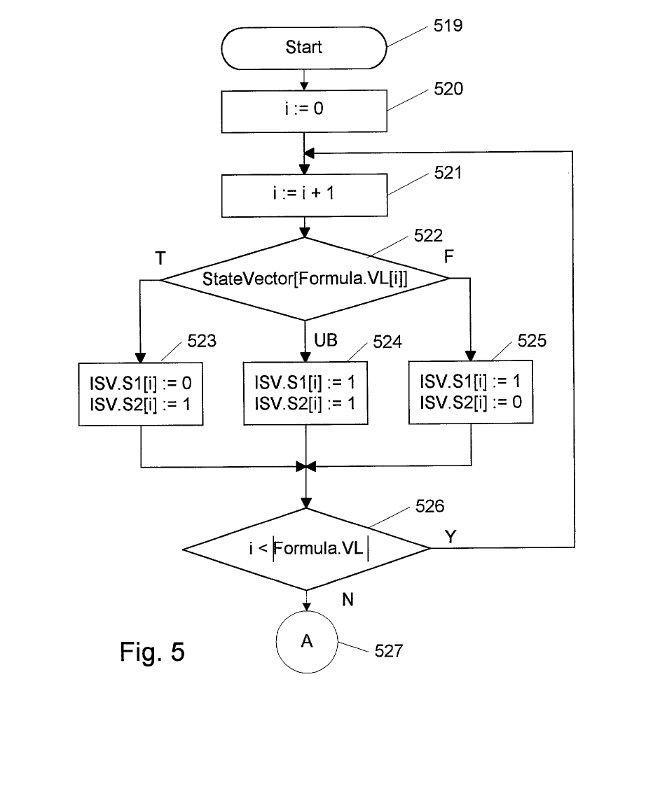

FIG. 5 shows a flow chart of a method of generating a local input state vector from a global input state vector. Start 519 is similar to start 413 of FIG. 4. First, a counter i is initialized to zero in step 520 in order to count over the variables in the formula. Then a loop is entered, and the first step 521 in the loop is to increment the counter i to i+1. The counter is used as an index in the formula variable list VL to get the variable which is again used as an index in the StateVector to extract the actual value of the variable either True, False or Unbound. In step 522 the variable value of the element number i in Formula.VL is recognized as either true (T), false (F), or unbound (UB). If the result of step 522 is true, then step 523 is entered, if the result is unbound, then step 524 in entered, and if the result is false, then step 525 is entered. In step 523 the bits S1 and S2 of variable number i are updated with S1:=0 and S2:=1. In step 524 the bits S1 and S2 of variable number i are updated with S1:=1 and S2:=1. In step 525 the bits S1 and S2 of variable number i are updated with S1:=1 and S2:=0. The loop is repeated until the truth value of all the variables in the formula has be transferred to the local input state vector (ISV). This is tested in step 526. If the counter i has reached the length of the formula variable list Formula.VL, then the loop is terminated, otherwise the loop is resumed with a counter increment in step 521. If the loop is terminated, the method continues with the scanning of uncompressed terms via the step A, 527.

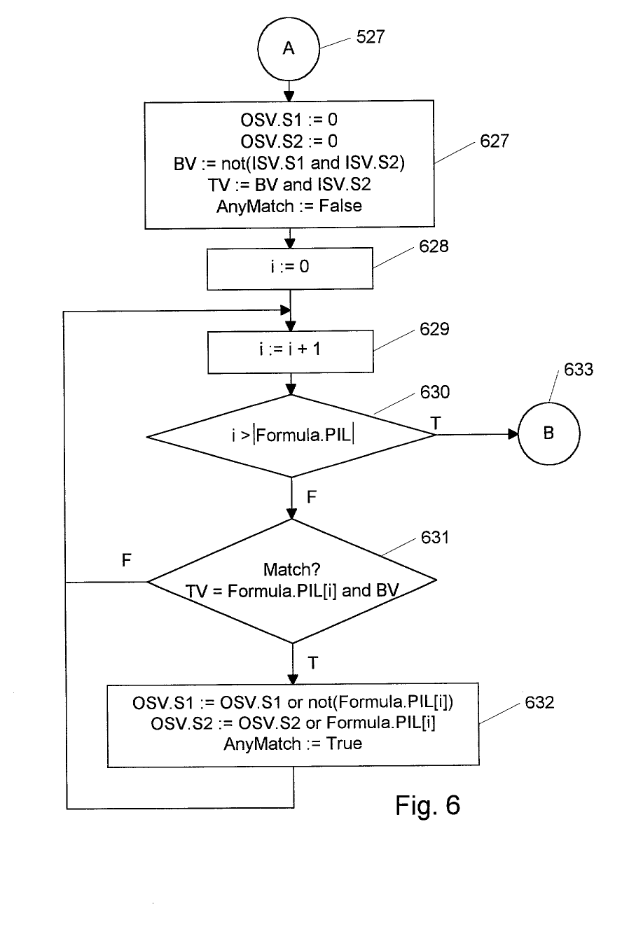

FIG. 6 shows a flow chart of a method of scanning uncompressed terms. The method of FIG. 5 continues via step A, 527. In step 627 initialization of variables regarding the scanning of uncompressed terms is performed. The local output state vector OSV is initialized to ‘contradiction’ by setting the two bits S1 and S2 to ‘0’. That is OSV[i] S1:=0, OSV[i].S2:=0, corresponding to that all elements are set to 0. The bounded variables in the local input state vector ISV are indicated with a bit mask BV by a binary ‘1’, that is BV:=not (ISV.S1 and ISV.S2). The true variables of the local input state vector are also indicated by a bit mask TV:=BV and ISV.S2. And finally the variable AnyMatch is set to false, Anymatch:=False. In step 628 the counter i is set to zero, i:=0. This counter is used to count over the uncompressed terms in the positive index list, PIL, of the formula. Step 629 increments the counter i and is the first step of a loop. The loop is terminated in step 630 if all the PIL terms have been scanned, here tested whether the counter i has reached the length of the formulas PIL list, that is, is i=|Formula.PIL|. Detection of whether there is a match or not is carried out in step 631, wherein the truth value of the statement

TV=Formula.PIL[i] and BV

is tested. If this statement is false, then the loop is resumed with a counter increment in step 629, otherwise the local output state vector is updated along with the variable AnyMatch, before the loop is resumed in step 629. The update is as follows:

OSV.S1:=OSV.S1 or not (Formula.PIL[i])

OSV.S2:=OSV.S2 or Formula.PIL[i]

AnyMatch:=True

If no match exists, then the OSV is not updated and a contradiction is detected. When the loop is finished, as detected in step 630, the method continues with scanning of the compressed terms via the step B, 633.

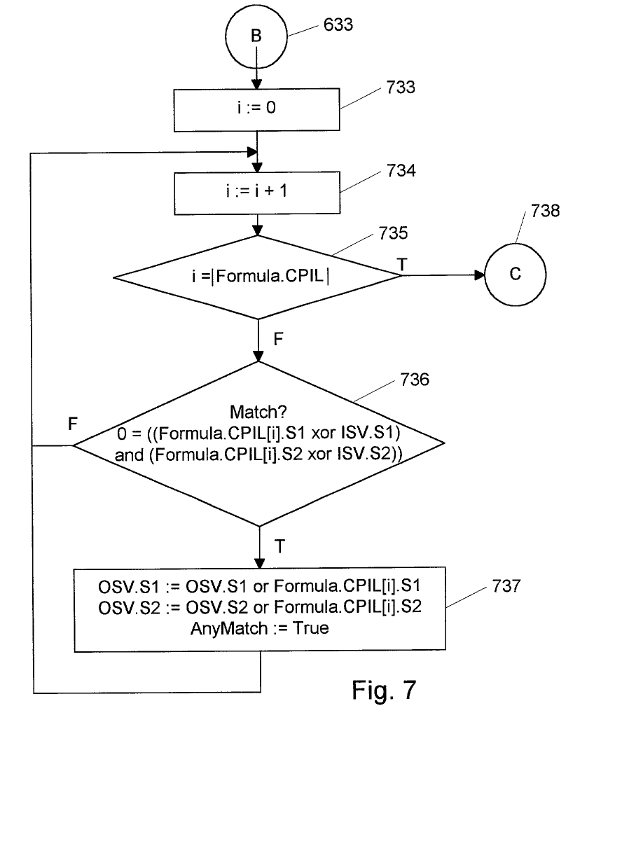

FIG. 7 shows a flow chart of a method of scanning compressed terms. The method of FIG. 6 continues via the step B, 633. In step 733 the counter i is set to zero, i:=0. The counter is used to count over the compressed terms in the compressed positive index list, CPIL, of the formula. Step 734 increments the counter i and is the first step of a loop. The loop is terminated in step 735 if all the CPIL terms have been scanned, here tested whether the counter i has reached the length of the formulas CPIL list, that is, is i=|Formula.CPIL|. Detection of whether there is a match or not is carried out in step 736, wherein the truth value of the statement

0=((Formula.CPIL[i].S1 xor ISV.S1) and

(Formula.CPIL[i].S2 xor ISV.S2))

is tested. If this statement is false, then the loop is resumed with a counter increment in step 734, otherwise the local output state vector is updated along with the variable AnyMatch, before the loop is resumed in step 629. The update is as follows:

OSV.S1:=OSV.S1 or Formula.CPEL[i].S1

OSV.S2:=OSV.S2 or Formula.CPEL[i].S2

AnyMatch:=True

If no match exists, then the OSV is not updated and a contradiction is detected. When the loop is finished, as detected in step 735, the method continues with an information extraction via step C, 738.

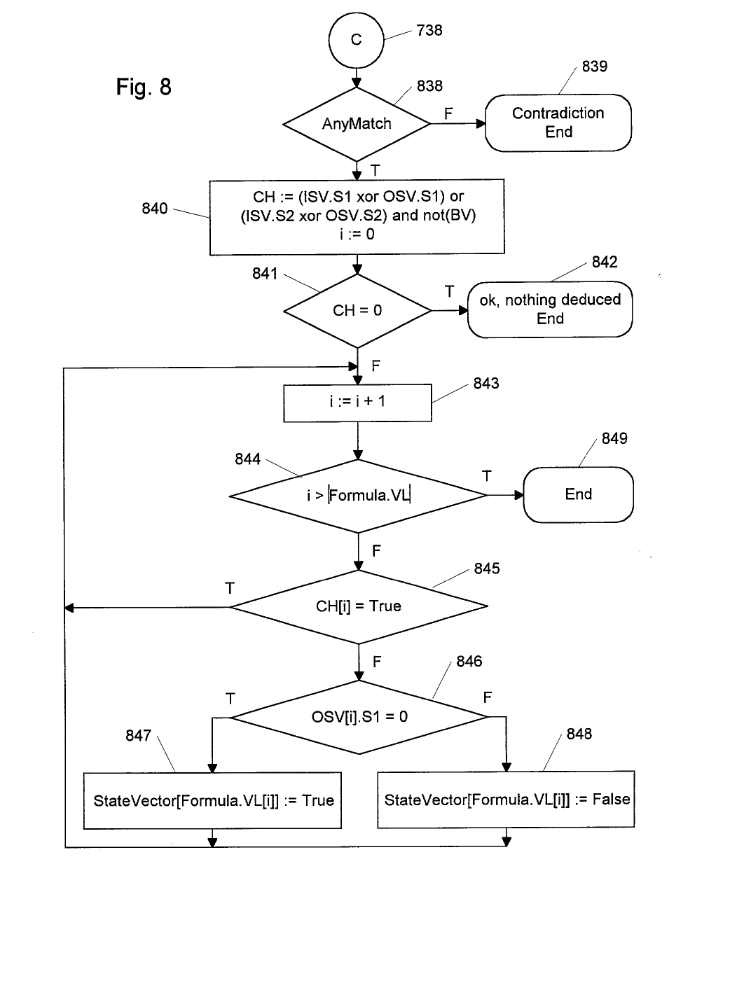

FIG. 8 shows a flow chart of a method of extracting information. The method of FIG. 7 continues via the step C, 738. If no match is detected in step 838, for either the compressed or uncompressed terms, then the request in the form of the input state vector is in contradiction with the rule representation and thereby the rule. This result is provided in step 839 if the variable AnyMatch is false. Alternatively the detection is performed by calculating the truth value of the statement: 0=(OSV.S1 or OSV.S2).

The variable that has been changed due to the scanning process es extracted by comparing the local input state vector (ISV) to the output state vector (OSV) and removing all bound variables indicated by BV in the change vector CV. That is, a true variable could match a unbound variable. The changed variables are indicated in step 840 in the vector CH by means of the statement:

CH:=(ISV.S1 xor OSV.S1) or (ISV.S2 xor OSV.S2) and not (BV)

If the change vector only contains zeros, then the scanning has reveiled no new information, and the algorithm may then report this. That is, the request is valid according to the rule. In step 841 it is tested whether CH is equal to 0, and if CH is equal to 0, then in step 842 it is concluded that nothing is deduced and the method terminates. The method ends, and it has deduced variables which are reported. In step 841 the counter i is incremented in the beginning of the loop. This loop is repeated until the truth value af all the deduced variables in the local output state vector (OSV) have been transferred to the StateVector SV, here tested in step 844 whether the counter i has reached the length of the formula variable list VL. That is, is i<|Formula.VL|?. If the result is no, then the method terminates in step 849, otherwise the method continues in step 845. In step 845 it is tested whether the value of element i in the vector CH is true. If the value of the element is true, then it is tested, in step 846, whether bit S1 in the element i of the local output state vector is true, that is is OSV[i].S1=0 ?. If it is true, then the StateVector[Formula.VL[i]] is set to true in step 847, otherwise StateVector[Formula.VL[i]] is set to false. When step 847 or step 848 is executed, then the loop resumes with a counter increment in step 843. Likewise, the loop resumes if the result of step 845 is false.

### EXAMPLE 5 (CONTINUED II)

Remember the rule

X [symbol] (Y or Z)

where the formula representation is

{[X,Y,Z], [101], [{111,011},{001,111}]}.

Furthermore, it is known that X is assigned to true and Z is assigned to false.

Start at stage one: Generate local input state vector

(X) StateVector[1]=True

(Y) StateVector[2]=Unbound

(Z) StateVector[3]=False

isv={011, 110}, osv={000,000}, TV=[100], BV=[101]

Stage two: Scan uncompressed terms

Match ? (Formula.PIL[i] and BV) xor TV

PIL[1]: (101 and 101) xor 100=101 xor 101=001 (No match)

isv={011, 110}, osv {000,000}, TV=[100], BV=[101]

Stage three: Scan compressed terms

Match ? ((Formula.CPIL[1].s1 xor isv.s1) and (Formula.CPIL[1].s2 xor isv.s2))

[{111,011}, {001,111}

CPIL[1]: (111 xor 011) and (011 xor 110) 100 and 101=100 (No Match) Continue

CPIL[2]: (001 xor 011) and (111 xor 110)=010 and 001=000 (Match)

osv.s1:=osv.s1 or Formula.CPIL[2].s1=000 or 001=001

osv.s2:=osv.s2 or Formula.CPIL[2].s2=000 or 111=111

isv={011, 110}, osv={001,111}, TV=[100], BV=[101]

Stage four: Extract information from scanning

CH=((isv.s1 xor osv.s1) or (isv.s2 xor osv.s2)) and !BV

=(011 xor 001) or (110 xor 111) and !101

=(010 or 001) and 010=011 and 010=010

Local StateVector[2]={0,1}=True

Therefore Y equals True, as expected.

### EXAMPLE 6

This example is taken from the field of configuration.

The relations between the selectable elements for a car, the rule, or constraint may be:

Model[Turbo] or Model[Cabriolet] [symbol] MetalicPaints and Trim[Leather] and CruiseControl

Instead of using the above terms we abbreviate these to more readable variable names:

Model[Turbo]=A

Model[Cabriolet]=B

MetalicPaints=C

Trim[Leather]=D

CruiseControl=E

The above constraint abbreviates to the following formula:

A or B [symbol] C and D and E

We can now commence the Fast Boolean Scanning algorithm. Leftmost is the point at which the ActiveList and the ResultList are shown. p4_{—}5 indicates the point between step 4 and step 5, likewise p9_{—}10 indicates the point between step 9 and step 10. For each iteration it is shown what the terms T, T1 and T2 are assigned.

Referring to FIG. 1 ‘generating a compressed rule repre-
sentation’:

| Point: | ActiveList: | ResultList: |
|---|---|---|
| p2_3 | { } | { } |

T=0, T1=A, T2=!A

| | | |
|---|---|---|
| p4_5 | { } | { } |
| p4_5 | {A} | { } |
| p9_10 | {A, !A} | { } |

T=A, T1=AB, T2=A!B

| | | |
|---|---|---|
| p4_5 | {!A} | { } |
| p4_5 | {!A, AB} | { } |
| p9_10 | {!A, AB, A!B} | { } |

T=!A, T1=!AB, T2=!A!B

| | | |
|---|---|---|
| p4_5 | {AB, A!B} | { } |
| p4_5 | {AB, A!B, !AB} | { } |
| p9_10 | {AB, A!B, !AB} | {!A!B} |

T=AB, T1=ABC, T2 = AB!C

| | | |
|---|---|---|
| p4_5 | {A!B, !AB} | {!A!B} |
| p4_5 | {A!B, !AB, ABC} | {!A!B} |
| p9_10 | {A!B, !AB, ABC} | {!A!B} |

T=A!B, T1=A!BC, T2=A!B!C

| | | |
|---|---|---|
| p4_5 | {!AB, ABC} | {!A!B} |
| p4_5 | {!AB, ABC, A!BC} | {!A!B} |
| p9_10 | {!AB, ABC, A!BC} | {!A!B} |

T=!AB, T1=!ABC, T2=!AB!C

| | | |
|---|---|---|
| p4_5 | {ABC, A!BC} | {!A!B} |
| p4_5 | {ABC, A!BC, !ABC} | {!A!B} |
| p9_10 | {ABC, A!BC, !ABC} | {!A!B} |

T=ABC, T1=ABCD, T2=ABC!D

| | | |
|---|---|---|
| p4_5 | {A!BC, !ABC} | {!A!B} |
| p4_5 | {A!BC, !ABC, ABCD} | {!A!B} |
| p9_10 | {A!BC, !ABC, ABCD} | {!A!B} |

T=A!BC, T1=A!BCD, T2=A!BC!D

| | | |
|---|---|---|
| p4_5 | {!ABC, ABCD} | {!A!B} |
| p4_5 | {!ABC, ABCD, A!BCD} | {!A!B} |
| p9_10 | {!ABC, ABCD, A!BCD} | {!A!B} |

T1=!ABC, T1=!ABCD, T2 = !ABC!D

| | | |
|---|---|---|
| p4_5 | {ABCD, A!BCD} | {!A!B} |
| p4_5 | {ABCD, A!BCD, !ABCD} | {!A!B} |
| p9_10 | {ABCD, A!BCD, !ABCD} | {!A!B} |

T=ABCD, T1=ABCDE, T2=ABCD!E

| | | |
|---|---|---|
| p4_5 | {A!BCD, !ABCD} | {!A!B} |
| p4_5 | {A!BCD, !ABCD} | {!A!B, ABCDE} |
| p9_10 | {A!BCD, !ABCD} | {!A!B, ABCDE} |

T=A!BCD, T1 = A!BCDE, T2=ABCD!E

| | | |
|---|---|---|
| p4_5 | {!ABCD} | {!A!B, ABCDE} |
| p4_5 | {!ABCD} | {!A!B, ABCDE, A!BCDE} |
| p9_10 | {!ABCD} | {!A!B, ABCDE, A!BCDE} |

T=ABCD, T1=ABCDE, T2=ABCD!E

| | | |
|---|---|---|
| p4_5 | { } | {!A!B, ABCDE, A!BCDE} |
| p4_5 | { } | {!A!B, ABCDE, A!BCDE, |
| | | !ABCDE} |
| End | { } | {!A!B, ABCDE, A!BCDE, |
| | | !ABCDE} |

The result can now be translated into the two-bit representation given in table 16:

TABLE 6

| Term No. | A | B | C | D | E |
|---|---|---|---|---|---|
| 1 | 0 | 0 | * | * | * |
| 2 | 1 | 1 | 1 | 1 | 1 |
| 3 | 1 | 0 | 1 | 1 | 1 |
| 4 | 0 | 1 | 1 | 1 | 1 |

Resulting in the following representation

Formula=([A,B,C,D,E], [11111,10111,01111], [{11111, 00111}])

Referring to FIG. 5 ‘generating a local input state vector’:

Now, in the formula A or B [symbol] C and D and E a user may have chosen B=False and E=True corresponding to having made the choices of discarding the Cabriolet model, but selecting Cruise Control.

Initially, we have the following data structures from above:

Formula.VariableList=[A,B,C,D,E]

Formula.PositiveIndexList=[11111,10111,01111]

Formula.CompressedPositiveIndexList=[{11111,00111}]

At the point A (after the first loop) the InputStateVector has been assigned.

isv.s1=11110

isv.s2=10111

After A the OutputStateVector is, BoundVariable, TrueVariable and AnyMatch are initiallized to

osv.s1=0

osv.s2=0

BV=not (isv.s1 and isv.s2)=not (11110 and 10111)

=not 10110=01001

TV=BV and isv.s2=01001 and 10111=00001

AnyMatch=False

Referring to FIG. 6 ‘scanning of uncompressed terms’:

The following shows 631 and 632 at each iteration of the loop 629 to 632.

| | |
|---|---|
| i = 1: | |
| 631) | TV = Formula.PIL[i] and BV |
| | 00001 = 11111 and 01001 |
| | 00001 = 01001 |
| | False |
| i = 2 | |
| 631) | TV = Formula.PIL[i] and BV |
| | 00001 = 10111 and 01001 |
| | 00001 = 00001 |
| | True |
| 632) | osv.s1 := osv.s1 or not Formula.PIL[i] |
| | := 00000 or not 10111 |
| | := 01000 |
| | osv.s2 := osv.s2 or Formula.PIL[i] |
| | := 00000 or 10111 |
| | := 10111 |
| i = 3 | |
| 631) | TV = Formula.PIL[i] and BV |
| | 00001 = 01111 and 01001 |
| | 00001 = 01001 |
| | Flase |

At B the output state vector is thus assigned:
osv.s1 = 01000
osv.s2 = 10111

Referring to FIG. 7 ‘scanning compressed terms’:

The loop from 734 to 737 is only executed once as the Compressed Possitive Index List only contains one element.

| | |
|---|---|
| 736) | 0 = (Formula.CPIL[i].s1 xor isv.s1) and |
| | (Formula.CPIL[i].s2 xor isv.s2) |
| | 0 = (11111 xor 11110) and (00111 xor 10111) |
| | 0 = 00001 and 10000 |
| | 0 = 00000 |
| | True |
| 737) | osv.s1 := osv.s1 or Formula.CPIL[1].s1 |
| | := 01000 or 11111 |
| | := 11111 |
| | osv.s2 := osv.s2 or Formula.CPIL[1]s2 |
| | := 10111 or 00111 |
| | := 10111 |
| | AnyMatch := True |

Now because AnyMatch was assigned True, the test at (38) is passed, and the algorithm proceeds to (40) where CH is initialized to:

Referring to FIG. 8 ‘extracting information’:

| CH | := ((isv.s1 xor osv.s1) or (isv.s2 xor osv.s2)) |
|---|---|
| | and not BV |
| CH | := ((11110 xor 11111) or (10111 xor 10111)) and |
| | not 01001 |
| | := (00001 or 00000) and 10110 |
| | := 00001 and 10110 |
| | := 00000 |

After the loop from 844 to 848 no elements of the state vector are changed (deduced to either true or false). It is, however, verified that the state vector does not lead to any contradictions.

The invention may be embodied as a computer program or a part of a computer program, which may be loaded into the memory of a computer and executed therefrom. The computer program may be distributed by means of any data storage or data transmission medium. The storage media can be magnetic tape, optical disc, compact disc (CD or CD-ROM), mini-disc, hard disk, floppy disk, ferroelectric memory, electrically erasable programmable read only memory (EEPROM), flash memory, EPROM, read only memory (ROM), static random access memory (SRAM), dynamic random access memory (DRAM), ferromagnetic memory, optical storage, charge coupled devices, smart cards, etc. The transmission medium can be a network, e.g. a local area network (LAN), a wide area network (WAN), or any combination thereof, e.g. the Internet. The network may comprise wire and wire-less communication links. Via the network a software embodiment (i.e. a program) of the invention, or a part thereof, may be distributed by transferring a program via the network.

1. A method of processing a request to a rule by the use of an input signal, compressed rule information, and an output signal, comprising the steps of:
representing said input signal as a plurality of two-bit pairs, each pair corresponding to a variable in said input signal;
representing the rule information with at least a first and a second type of terms; each of said terms of the first type being binary words and each representing one allowable combination of the variables; each of said terms of the second type being a plurality of two-bit pairs and representing at least two allowable combinations of the variables;
testing whether there is a first type of match between at least one of said first terms and said input signal;
testing whether there is a second type of match between at least one of said second terms and said input signal;
generating an output signal as a plurality of two-bit pairs, each pair corresponding to a variable in said input signal;
updating said output signal according to the following strategy:
if there is a match of said first type, then the output signal is updated with values which are responsive to at least one of said first type of terms;
if there is a match of said second type, then the output signal is updated with values which are responsive to at least one of said second type of terms.

2. The method according to claim 1, further comprising the step of:
generating said input signal as a subset of variables from a global input signal, wherein said subset of variables is determined as those variables involved in said rule.

3. The method according to claim 2, further comprising the step of:
generating a global output signal having variables, wherein some of the variables are updated with variable values from said output signal.

4. The method according to claim 1, further comprising the step of:
taking all of the first bits of the pairs in said output signal as a first signal component and the second bits as a second signal component.

5. The method according to claim 1, wherein said input and output signals comprise variables which each may take one of the following symbolic representations: true false, tautology, or contradiction.

6. The method according to claim 5, wherein said symbolic representations have the following values:

| | | |
|---|---|---|
| 0 | 1 | true |
| 1 | 0 | false |
| 1 | 1 | tautology |
| 0 | 0 | contradiction |

7. The method according to claim 6, wherein all variables in said output signal are initalized with the symbolic representation ‘contradiction’, meaning that all bits are initialized with a binary ‘0’.

8. The method according to claim 1, wherein said first type of terms has a number of variables corresponding to the number of variables in the rule, and each variable may take the value true or false.

9. The method according to claim 1, wherein said second type of terms has a number of variables corresponding to the number of variables in the rule, and each variable may take one of the symbolic representations true, false, or tautology.

10. The method according to claim 9, wherein said symbolic representations have the following values:

| | | |
|---|---|---|
| 0 | 1 | true |
| 1 | 0 | false |
| 1 | 1 | tautology |

11. The method according to claim 4, further comprising the step of:
taking all of the first bits of the pairs in the terms of said second type of terms as a first term component and the second bits as a second term component.

12. The method according to claim 1, wherein said test for a first or a second type of match is carried out by means of at least one Boolean operator.

13. The method according to claim 4, wherein the test for a first type of match is true if a binary mask indicating variables in the input signal with the symbolic representation ‘true’ is equal to an and-combination of a term of said first type and the complement to a binary mask indicating the bounded variables in said input signal.

14. The method according to claim 1, wherein said update of said output signal is further responsive to one or more previous variable values in said output signal.

15. The method according to claim 13, wherein said output signal is updated by applying the following strategy: if the result of said first type of test is true, then those variables in said output signal corresponding to the variables in said term for which there is a match are updated such that said first signal component is updated with an or-combination of the previous variable values in said first signal component and the complement to said binary term for which there is a match, and such that said second signal component is updated with an or-combination of the previous variable values in said second signal component and said binary term for which there is a match.

16. The method according to claim 4, wherein said test for said first type of match is true if an and-combination of a xor-combination of said first term component for which term there is a match and said first input signal component and a xor-combination of said second term component for which term there is a match and said second input signal component is equal to a binary ‘0’ or Boolean false.

17. The method according to claim 16, wherein said output signal is updated by applying the following strategy: if the result of said second type of test is true, then those variables in said output signal corresponding to the variables in said term for which there is a match are updated such that said first signal component is updated with an or-combination of the previous variable values in the first signal component and said second term component for which there is a match, and such that said second signal component is updated with an or-combination of the previous variable values in said second signal component and said second term component for which there is a match.

18. The method according to claim 1, further comprising the following information retrieving strategy:
if no match is detected, then said output signal contains contradiction information;
if no variables are updated in said output signal then nothing is deduced;
otherwise said output signal is updated with the symbolic representations true or false.

19. The method according to claim 1, wherein updated variables in said output signal are indicated by an or-combination of a xor-combination of said first input signal component and said first output signal component and a xor combination of said second input signal component and said second output signal component, and'ed with the complement to a binary mask indicating the bounded variables in said input signal.

20. The method according to claim 1, wherein said rule represents possible variable combinations for Boolean rules.

21. A method of processing a request to a rule by the use of an input signal, compressed rule information, and an output signal, comprising the steps of:
representing the input signal as a plurality of two-bit pairs, each pair corresponding to a variable in the input signal;
representing the rule information with at least one type of terms; each of the terms of said type being a plurality of two-bit pairs and representing at least one allowable combination of the variables;
testing whether there is a match between at least one of said terms and said input signal;
updating an output signal which is a plurality of two-bit pairs such that if there is a match, then the output signal is updated with values which are responsive to at least one of said terms.

22. The method according to claim 21 further comprising the step of:
generating said input signal as a subset of variables from a global input signal, wherein said subset of variables is determined as those variables involved in said rule.

23. The method according to claim 22 further comprising the step of:
generating a global output signal having variables wherein some of the variables are updated with variable values from said output signal.

24. The method according to claim 21 further comprising the step of
taking all of the first bits of the pairs in said output signal as a first signal component and the second bits as a second signal component.

25. The method according to claim 21, wherein said input and output signals comprise variables which each may take one of the following symbolic representations: true, false, tautology, or contradiction.

26. The method according to claim 25, wherein said symbolic representations have the following values:

| | | |
|---|---|---|
| 0 | 1 | true |
| 1 | 0 | false |
| 1 | 1 | tautology |
| 0 | 0 | contradiction |

27. The method according to claim 26, wherein all variables in said output signal are initalized with the symbolic representation ‘contradiction’, meaning that all bits are initialized with a binary ‘0’.

28. The method according to claim 21, wherein said second type of terms has a number of variables corresponding to the number of variables in the rule, and each variable may take one of the symbolic representations true, false, or tautology.

29. The method according to claim 28, wherein said symbolic representations have the following values:

| | | |
|---|---|---|
| 0 | 1 | true |
| 1 | 0 | false |
| 1 | 1 | tautology |

30. The method according to claim 24, further comprising the step of:
taking all of the first bits of the pairs in the terms of said second type of terms as a first term component and the second bits as a second term component.

31. The method according to claim 21, wherein said test for a first or second type of match is carried out by means of at least one Boolean operator.

32. The method according to claim 21, wherein said update of said output signal is further responsive to one or more previous variable values in said output signal.

33. The method according to claim 24, wherein said test for said first type of match is true if an and-combination of a xor-combination of said first term component for which term there is a match and said first input signal component and a xor-combination of said second term component for which term there is a match and said second input signal component is equal to a binary ‘0’ or Boolean false.

34. The method according to claim 33, wherein said output signal is updated by applying the following strategy: if the result of said second type of test is true, then those variables in said output signal corresponding to the variables in said term for which there is a match are updated such that said first signal component is updated with an or-combination of the previous variable values in the first signal component and said second term component for which there is a match, and such that said second signal component is updated with an or-combination of the previous variable values in said second signal component and said second term component for which there is a match.

35. The method according to claim 21, further comprising the following information retrieving strategy:
if no match is detected, then said output signal contains contradiction information;
if no variables are updated in said output signal then nothing is deduced;
otherwise, said output signal is updated with the symbolic representations true or false.

36. The method according to claim 21, wherein updated variables in said output signal are indicated by an or-combination of a xor-combination of said first input signal component and said first output signal component and a xor combination of said second input signal component and said second output signal component, and'ed with the complement to a binary mask indicating the bounded variables in said input signal.

37. The method according to claim 21, wherein said rule represents possible variable combinations for Boolean rules.

38. A method of processing a request to a rule by the use of an input signal, compressed rule information, and an output signal, comprising the steps of:
representing said input signal as a plurality of bit structures, each structure corresponding to a variable in said input signal;
representing the rule information with at least a first and a second type of terms; each of said terms of the first type being binary words and each representing one allowable combination of the variables; each of said terms of the second type being a plurality of bit structures and representing at least two allowable combinations of the variables;
testing whether there is a first type of match between at least one of said first terms and said input signal;
testing whether there is a second type of match between at least one of said second terms and said input signal;
generating an output signal as a plurality of bit structures, each structure corresponding to a variable in said input signal;
updating said output signal correspondingly, if there is a match of one of said types.

39. A computer readable medium encoded with a program for performing a method of processing a request to a rule by the use of an input signal, compressed rule information, and an output signal, comprising the steps of:
representing said input signal as a plurality of two-bit pairs, each pair corresponding to a variable in said input signal;
representing the rule information with at least a first and a second type of terms; each of said terms of the first type being binary words and each representing one allowable combination of the variables; each of said terms of the second type being a plurality of two-bit pairs and representing at least two allowable combinations of the variables;
testing whether there is a first type of match between at least one of said first terms and said input signal;
testing whether there is a second type of match between at least one of said second terms and said input signal;
generating an output signal as a plurality of two-bit pairs, each pair corresponding to a variable in said input signal;
updating said output signal according to the following strategy:
if there is a match of said first type, then the output signal is updated with values which are responsive to at least one of said first type of terms;
if there is a match of said second type, then the output signal is updated with values which are responsive to at least one of said second type of terms.

40. The medium according to claim 39, further comprising the step of:
generating said input signal as a subset of variables from a global input signal, wherein said subset of variables is determined as those variables involved in said rule.

41. The medium according to claim 40, further comprising the step of:
generating a global output signal having variables, wherein some of the variables are updated with variable values from said output signal.

42. The medium according to claim 39, further comprising the step of:
taking all of the first bits of the pairs in said output signal as a first signal component and the second bits as a second signal component.

43. The medium according to claim 39, wherein said input and output signals comprise variables which each may take one of the following symbolic representations: true false, tautology, or contradiction.

44. The medium according to claim 43, wherein said symbolic representations have the following values:

| | | |
|---|---|---|
| 0 | 1 | true |
| 1 | 0 | false |
| 1 | 1 | tautology |
| 0 | 0 | contradiction |

45. The medium according to claim 44, wherein all variables in said output signal are initalized with the symbolic representation ‘contradiction’, meaning that all bits are initialized with a binary ‘0’.

46. The medium according to claim 39, wherein said first type of terms has a number of variables corresponding to the number of variables in the rule, and each variable may take the value true or false.

47. The medium according to claim 39, wherein said second type of terms has a number of variables corresponding to the number of variables in the rule, and each variable may take one of the symbolic representations true, false, or tautology.

48. The medium according to claim 47, wherein said symbolic representations have the following values:

| | | |
|---|---|---|
| 0 | 1 | true |
| 1 | 0 | false |
| 1 | 1 | tautology |

49. The medium according to claim 42, further comprising the step of:
taking all of the first bits of the pairs in the terms of said second type of terms as a first term component and the second bits as a second term component.

50. The medium according to claim 39, wherein said test for a first or a second type of match is carried out by means of at least one Boolean operator.

51. The medium according to claim 42, wherein the test for a first type of match is true if a binary mask indicating variables in the input signal with the symbolic representation ‘true’ is equal to an and-combination of a term of said first type and the complement to a binary mask indicating the bounded variables in said input signal.

52. The medium according to claim 39, wherein said update of said output signal is further responsive to one or more previous variable values in said output signal.

53. The medium according to claim 51, wherein said output signal is updated by applying the following strategy: if the result of said first type of test is true, then those variables in said output signal corresponding to the variables in said term for which there is a match are updated such that said first signal component is updated with an or-combination of the previous variable values in said first signal component and the complement to said binary term for which there is a match, and such that said second signal component is updated with an or-combination of the previous variable values in said second signal component and said binary term for which there is a match.

54. The medium according to claim 42, wherein said test for said first type of match is true if an and-combination of a xor-combination of said first term component for which term there is a match and said first input signal component and a xor-combination of said second term component for which term there is a match and said second input signal component is equal to a binary ‘0’ or Boolean false.

55. The medium according to claim 54, wherein said output signal is updated by applying the following strategy: if the result of said second type of test is true, then those variables in said output signal corresponding to the variables in said term for which there is a match are updated such that said first signal component is updated with an or-combination of the previous variable values in the first signal component and said second term component for which there is a match, and such that said second signal component is updated with an or-combination of the previous variable values in said second signal component and said second term component for which there is a match.

56. The medium according to claim 39, further comprising the following information retrieving strategy:
if no match is detected, then said output signal contains contradiction information;
if no variables are updated in said output signal then nothing is deduced;
otherwise said output signal is updated with the symbolic representations true or false.

57. The medium according to claim 39, wherein updated variables in said output signal are indicated by an or-combination of a xor-combination of said first input signal component and said first output signal component and a xor combination of said second input signal component and said second output signal component, and'ed with the complement to a binary mask indicating the bounded variables in said input signal.

58. The medium according to claim 39, wherein said rule represents possible variable combinations for Boolean rules.

59. A computer readable medium encoded with a program for performing a method of processing a request to a rule by the use of an input signal, compressed rule information, and an output signal, comprising the steps of:
representing the input signal as a plurality of two-bit pairs, each pair corresponding to a variable in the input signal;
representing the rule information with at least one type of terms; each of the terms of said type being a plurality of two-bit pairs and representing at least one allowable combination of the variables;
testing whether there is a match between at least one of said terms and said input signal;
updating an output signal which is a plurality of two-bit pairs such that if there is a match, then the output signal is updated with values which are responsive to at least one of said terms.

60. The medium according to claim 59 further comprising the step of:
generating said input signal as a subset of variables from a global input signal, wherein said subset of variables is determined as those variables involved in said rule.

61. The medium according to claim 60 further comprising the step of:
generating a global output signal having variables wherein some of the variables are updated with variable values from said output signal.

62. The medium according to claim 59 further comprising the step of
taking all of the first bits of the pairs in said output signal as a first signal component and the second bits as a second signal component.

63. The medium according to claim 59, wherein said input and output signals comprise variables which each may take one of the following symbolic representations: true, false, tautology, or contradiction.

64. The medium according to claim 63, wherein said symbolic representations have the following values:

| | | |
|---|---|---|
| 0 | 1 | true |
| 1 | 0 | false |
| 1 | 1 | tautology |
| 0 | 0 | contradiction |

65. The medium according to claim 64, wherein all variables in said output signal are initalized with the symbolic representation ‘contradiction’, meaning that all bits are initialized with a binary ‘0’.

66. The medium according to claim 59, wherein said second type of terms has a number of variables corresponding to the number of variables in the rule, and each variable may take one of the symbolic representations true, false, or tautology.

67. The medium according to claim 66, wherein said symbolic representations have the following values:

| | | |
|---|---|---|
| 0 | 1 | true |
| 1 | 0 | false |
| 1 | 1 | tautology |

68. The medium according to claim 62, further comprising the step of:
taking all of the first bits of the pairs in the terms of said second type of terms as a first term component and the second bits as a second term component.

69. The medium according to claim 59, wherein said test for a first or second type of match is carried out by means of at least one Boolean operator.

70. The medium according to claim 59, wherein said update of said output signal is further responsive to one or more previous variable values in said output signal.

71. The medium according to claim 62, wherein said test for said first type of match is true if an and-combination of a xor-combination of said first term component for which term there is a match and said first input signal component and a xor-combination of said second term component for which term there is a match and said second input signal component is equal to a binary ‘0’ or Boolean false.

72. The medium according to claim 71, wherein said output signal is updated by applying the following strategy: if the result of said second type of test is true, then those variables in said output signal corresponding to the variables in said term for which there is a match are updated such that said first signal component is updated with an or-combination of the previous variable values in the first signal component and said second term component for which there is a match, and such that said second signal component is updated with an or-combination of the previous variable values in said second signal component and said second term component for which there is a match.

73. The medium according to claim 59, further comprising the following information retrieving strategy:
if no match is detected, then said output signal contains contradiction information;
if no variables are updated in said output signal then nothing is deduced;
otherwise, said output signal is updated with the symbolic representations true or false.

74. The medium according to claim 59, wherein updated variables in said output signal are indicated by an or-combination of a xor-combination of said first input signal component and said first output signal component and a xor combination of said second input signal component and said second output signal component, and'ed with the complement to a binary mask indicating the bounded variables in said input signal.

75. The medium according to claim 59, wherein said rule represents possible variable combinations for Boolean rules.

76. A computer readable medium encoded with a program for performing a method of processing a request to a rule by the use of an input signal, compressed rule information, and an output signal, comprising the steps of:
representing said input signal as a plurality of bit structures, each structure corresponding to a variable in said input signal;
representing the rule information with at least a first and a second type of terms; each of said terms of the first type being binary words and each representing one allowable combination of the variables; each of said terms of the second type being a plurality of bit structures and representing at least two allowable combinations of the variables;
testing whether there is a first type of match between at least one of said first terms and said input signal;
testing whether there is a second type of match between at least one of said second terms and said input signal;
generating an output signal as a plurality of bit structures, each structure corresponding to a variable in said input signal;
updating said output signal correspondingly, if there is a match of one of said types.
